(19) United States
(12) Patent Application Publication
(10) Pub. No.: US 2008/0267112 A1
(43) Pub. Date: Oct. 30, 2008

(54) DEVICE FOR REPEATING RF SIGNALS THROUGH ELECTROMAGNETIC COUPLING

(75) Inventor: Thierry LUCIDARME, Montigny Le Bretonneux (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/108,495

(22) Filed: Apr. 23, 2008

(30) Foreign Application Priority Data
Apr. 25, 2007 (EP) 07290511.0

(51) Int. Cl. H04B 7/14

(52) U.S. Cl. 370/315

(57) ABSTRACT

A device is intended to repeat radiofrequency signals that must be exchanged between a station of a radio communication network and a communication terminal located within a space enclosed by walls. This device comprises an external repeater intended to be placed on the outer surface of a wall and comprising first electromagnetic coupling means coupled to first RF signal transmitting and/or receiving means, and an internal repeater intended to be placed on the inner surface of that same wall substantially facing the external repeater and comprising second electromagnetic coupling means coupled to second RF signal transmitting and/or receiving means. The first and second electromagnetic coupling means are configured so as to transfer, over waves, and through the wall, RF signals originating respectively from the first and second RF signal transmitting and/or receiving means.

The invention pertains to the field of radio frequency (RF) signal repetition, and more precisely, devices tasked with repeating RF signals between a station (potentially a base station (or its equivalent)) of a radio communication network and a communication terminal located in a space enclosed by walls, such as a building or a vehicle.

The term “radio communication network” as used herein refers to any type of radio (or wireless) cellular, or similar, network, in particular, GSM, UMTS (3GPP), CDMA, CDMA 2000 (3GPP2), FDD (“Frequency Division Duplex”), TDD (“Time Division Duplex”), WIMAX, evolved-UTRAN (also known as LTE (“Long-Term Evolution”)), and non-restrictively, certain FWA (“fixed wireless access”) local area networks with lower mobility.

Furthermore, the term “communication terminal” as used herein refers to any type of fixed or mobile (or portable) communication terminal capable of exchanging data with another communication terminal or a network equipment, using wires or waves. Consequently, it may be, among other things, a telephone or desktop computer connected to a local router or server and equipped with a radio communication interface; a mobile telephone; a laptop computer or personal digital assistant (or PDA) equipped with a radio communication interface; a server or local router equipped with a radio communication interface; a high-frequency radio receiver; or a terrestrial or satellite television receiver.

The exchange of RF signals between a station (potentially a base station (or equivalent)) and a (communication) terminal located in a space enclosed by walls is often difficult, due to the attenuation of the signals' intensity, notably caused by crossing a barrier (or barriers), the presence of an object (or objects) (notion of shadow), and/or the angle of incidence of said RF signals with respect to a barrier. For this reason, attenuations ranging from 30 to 40 dB may frequently occur, in particular in certain parts of buildings.

This attenuation disrupts, and sometimes renders impossible, certain telephone conversations (voice data transmission). However, it is even more disruptive for broadband communication, such as that used for transferring data, including broadband multimedia data (which requires the use of a higher order of modulation, and therefore a higher signal-to-noise ratio).

In order to improve the situation, miniaturized base stations (“micro BTS” or “femto BTS”) may be installed in buildings or vehicles, as may base station routers (or BTRs) with an IP (“Internet Protocol”) interface to the network. However, despite all efforts, this situation has proven burdensome, due to the installation and maintenance costs of equipment and cabling. Furthermore, it may lead to an increase in the number of concentration and management points of the capacity of the network, i.e. the base station controllers (called RNCs in the case of a UMTS network).

It is also possible to place a repeater on the outside of a building or vehicle. In particular, this is disclosed in the patent documents WO 03/058850 and U.S. Pat. No. 6,731,904.

More precisely, the patent document WO 03/058850 discloses the installation, on the outside of the building, of a repeater tasked with collecting downlink, respectively uplink, RF signals, and with retransmitting them (still in the form of RF signals) toward the inside of the building, or respectively a base station, using a high-gain antenna, i.e. one with a reflector. This solution makes it possible to overcome most of the causes from which attenuation originates, but it has also proved burdensome, bulky, and unattractive, owing to the use of a high-gain reflector.

Patent document U.S. Pat. No. 6,731,904 discloses the installation, a certain distance away from the building, of a repeater tasked with collecting downlink, respectively uplink, RF signals and retransmitting them with a 180° shift (still in the form of RF signals), after having amplified them, towards the building, or respectively a base station. This solution only makes it possible to overcome some of the causes from which attenuations originate.

As no known solution is fully satisfactory, the purpose of the invention is to improve the situation.

For this purpose, it discloses a device tasked with repeating radio frequency (RF) signals that must be exchanged between a station (potentially a base station (or equivalent)) of a radio communication network and the communication terminal located within a space enclosed by walls (a building or vehicle).

This repeater device is characterized by the fact that it comprises:
an external repeater intended to be placed on the outer surface of a wall, comprising first electromagnetic coupling means coupled to first means of transmitting and/or receiving RF signals, and
an internal repeater content to be placed on the inner surface of said wall, substantially facing the outer repeater, and comprising second electromagnetic coupling means coupled to second means of transmitting and/or receiving RF signals, and
said first and second electromagnetic coupling means being adapted in such a way as to transfer via waves, through the wall, RF signals originating respectively from the first and second means of transmitting and/or receiving RF signals.

The repeater device of the invention may include other characteristics that may be taken separately or in combination, in particular:
its first and second electromagnetic coupling means may, for example, be configured in the form of RF antennas that are sensitive to an electric field;
   in such a case, the RF antennas may, for example, be chosen from among monopole antennas, dipole antennas, and microstrip antennas;
in a first variant, its first and second electromagnetic coupling means may, for example, be configured in the form of antennas sensitive to the magnetic field;
in a second variant, its first and second electromagnetic coupling means may, for example, be configured in the form of optical signal transmitters and/or receivers;
its external repeater may comprise first electrical power means, and its internal repeater may comprise second electrical power means connected to a source of alternating current capable of transferring power to the first electrical power means through inductive coupling;
   the second electrical power means may comprise a winding connected to an alternating current power circuit, and the first electrical power means may comprise a winding intended to be placed facing the primary winding and connected to an electrical charging circuit tasked with delivering alternating current;
      the primary winding may, for example, have a diameter lower than that of the secondary winding;
      as a variant or complement, the first and/or second electrical power means may, for example, comprise flux concentration means;
      as a variant or complement, the second electrical power means may, for example, comprise conversion means tasked with converting the alternating current, which has a first frequency, into an alternating current which has a second frequency higher than the first frequency;
      as a variant or complement, the second electrical power means may, for example, comprise a higher number of turns;
as a variant, its external repeater may, for example, comprise first independent electrical power means;
   in such a case, the first electrical power means may, for example, comprise a solar cell and an electrical charging circuit connected to the solar cell(s) and adapted for delivering direct current;
the first electrical power means may, for example, comprise a battery connected to the electrical charging circuit;
the first and/or second electrical power means may, for example, comprise conversion means tasked with converting an alternating current into a direct current (to power an amplification and filtering circuit);
its external repeater may comprise first frequency conversion means tasked with converting a first frequency presented by the RF signals received by the first transmitting and/or receiving means into a third frequency before transmitting those RF signals to the first electromagnetic coupling means. In such a case, its internal repeater comprises second frequency conversion means tasked with converting the third frequency presented by the RF signals transferred to the second electromagnetic coupling means, via the first electromagnetic coupling means, to reset said frequency to the first frequency before transmitting said signals to the second transmitting and/or receiving means;
its internal repeater may comprise first frequency conversion means tasked with converting a second frequency of the RF signals received by the second transmitting and/or receiving means into a fourth frequency before transmitting these RF signals to the second electromagnetic coupling means. In such case, its external repeater comprises a second frequency conversion means tasked with converting the fourth frequency presented by the RF signals transferred to the first electromagnetic coupling means, via the second electromagnetic coupling means, to reset said frequency to the second frequency before transmitting said signals to the first transmitting and/or receiving means.

The invention is particularly well-suited, though in a nonexclusive fashion, to cellular (or mobile) networks, and more generally to any application requiring coverage inside a fixed closed space (a building) or mobile closed space (in particular a vehicle) using a waveform generated by a transmitter that is located within said closed space, such as a cellular base station, a satellite, a radio transmitter (or station) or a terrestrial or satellite television transmitter (or station).

Other characteristics and benefits of the invention shall become apparent upon examining the detailed description below, along with the attached drawings, in which:

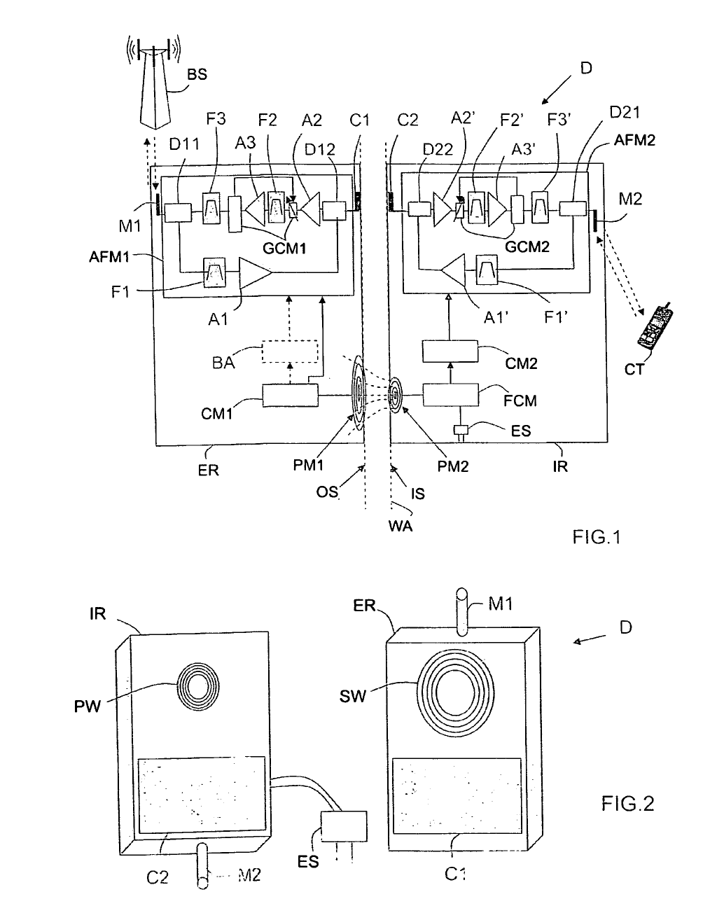

FIG. 1 schematically and functionally

illustrates an example embodiment of the repeater device of the invention, installed on a wall of a building,

FIG. 2 schematically illustrates, in a perspective view, a first example embodiment of the repeater device of the invention, in which the external and internal repeaters include monopole antenna RF signal transmitting/receiving means, respectively placed on the upper and lower sides, as well as microstrip antenna RF coupling means and inductive-coupling electrical power means on a side surface,

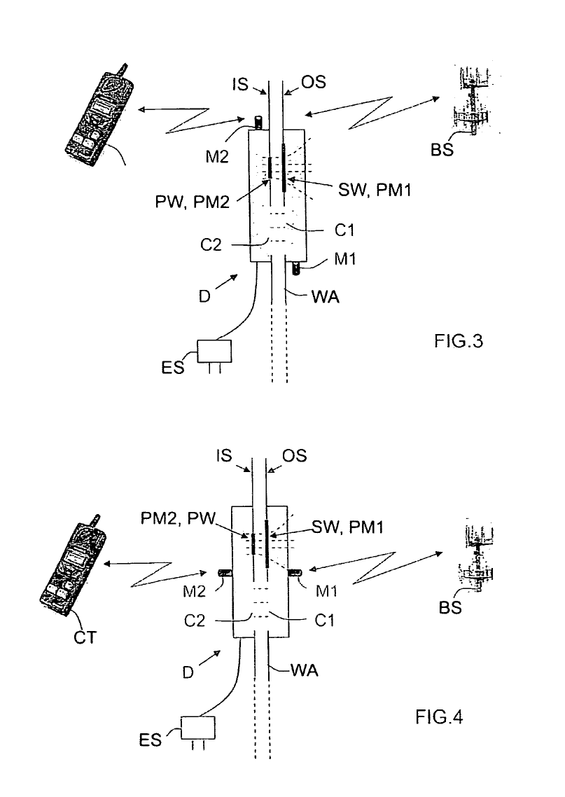

FIG. 3 schematically illustrates, in a cross-section view, the example embodiment of the repeater device of FIG. 2, installed on a wall,

FIG. 4 schematically illustrates, in a cross-section view, a variant of the example embodiment of the repeater device of FIGS. 2 and 3, installed on a wall,

FIG. 5 schematically and functionally illustrates an example embodiment of inductive-coupling electrical power means with primary and secondary windings,

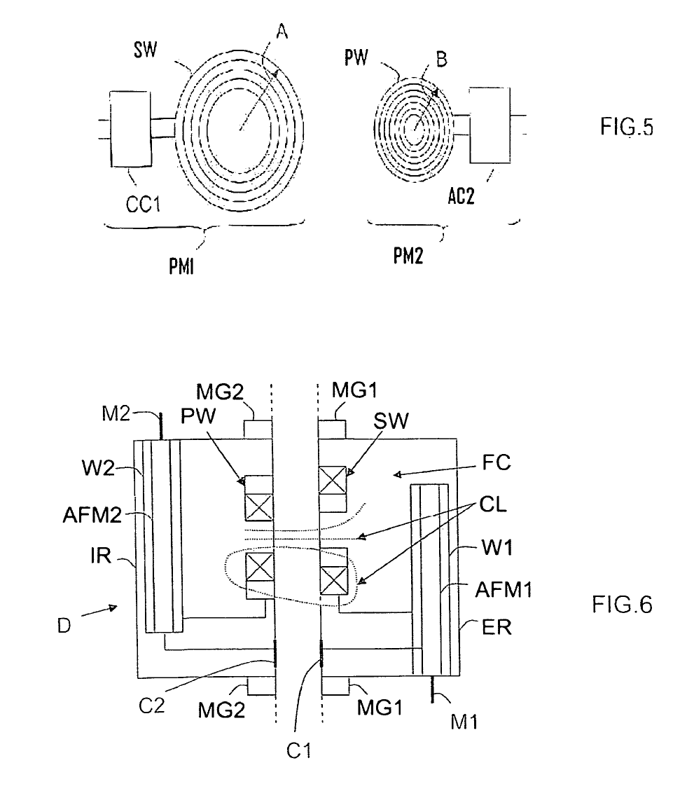

FIG. 6 schematically illustrates, in a cross-section view, another variant embodiment of the repeater device illustrated in FIGS. 2 and 3, in which the inductive-coupling electrical power means comprise flux concentration means,

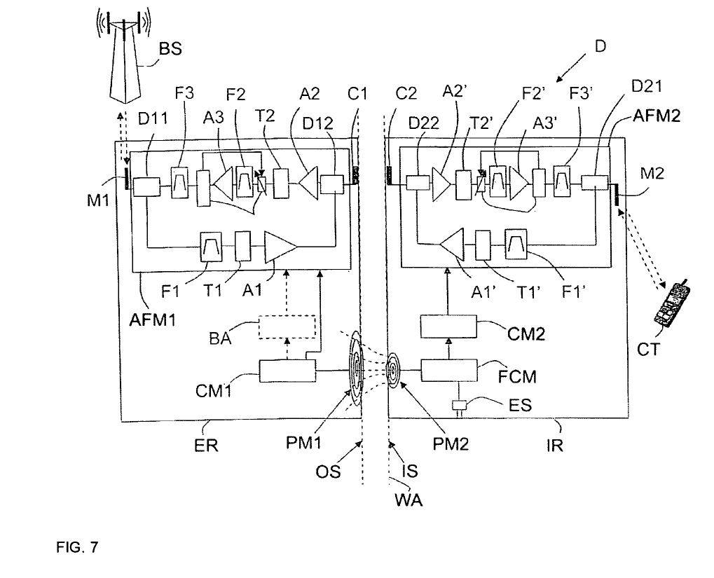

FIG. 7 schematically and functionally illustrates another example embodiment of the repeater device of the invention, with frequency translation, installed on a wall of a building.

The attached drawings may serve not only to complete the invention, but also to contribute to its definition, if need be.

The purpose of the invention is to enable the repetition of radio frequency (RF) signals between a station (potentially a base station (or equivalent)) of a radio communication network and a communication terminal located in a space enclosed by walls, such as a building or vehicle, by means of a low-cost and/or small-sized repeater device.

In the following description, the radio communication network is considered, for the purposes of a non-limiting example, to be a UMTS cellular network (or equivalent). However, the invention is not limited to this type of radio network. In fact, it pertains to any type of cellular or similar radio (or wireless) network, in particular GSM, CDMA, CDMA 2000, FDD, TDD, WiMAX, and evolved-UTRAN (or LTE) networks. Generally speaking, the invention pertains to any application requiring coverage inside a fixed closed space (a building) or mobile closed space (in particular a vehicle) using a waveform generated by an emitter that is located within said closed space, such as a cellular base station, a satellite, a radio emitter (or station) or a terrestrial or satellite television emitter (or station).

Furthermore, in the following description, as a non-limiting example, the communication terminals are considered to be installed in a building (an apartment, a house, or equivalent) and are mobile telephones. However, the invention is not limited to this type of space enclosed by walls, nor to this type of communication terminal. Rather, it also pertains to transportation vehicles, such as automobiles (cars, trucks, buses, and trailers), boats, trains, subways, trams, and airplanes. It further pertains to any type of fixed or mobile (or portable) communication terminal capable of exchanging data with another communication terminal or with a network device, using wires or waves, in particular telephones or desktop computers connected to a local router or server equipped with a radio communication interface; laptop computers and personal digital assistants (or PDAs) equipped with a radio communication interface; local routers or servers equipped with a radio communication interface; satellite or terrestrial television receivers, and high-frequency radio receivers.

As illustrated schematically, functionally, and in a non-limiting manner in FIG. 1, a repeater device D according to the invention comprises an external repeater ER and internal repeater IR.

The external repeater ER is intended to be placed on the outer surface OS of the wall WA of the building (or a vehicle) such as, for example, a window or structural wall. Any manner for fastening may be used, in particular suction cups, an adhesive, magnets MG1 (see FIG. 6), or screws.

This external repeater ER comprises first electromagnetic coupling means C1 which are coupled to first RF signal transmitting and/or receiving means M1. The latter (M1) are, in the example illustrated, of the transmitter-receiver type. They are tasked with receiving the RF signals transmitted by a base station (or its equivalent) BS, generally designated by the acronym BTS, of a radio network (in this example cellular), and with transmitting to said base station BS the RF signals which are transmitted to it by the first electromagnetic coupling means C1 and which come from communication terminals CT located in the building (via the internal repeater IR). To do so, they may include any type of antenna adapted to the desired application, such as a monopole antenna (as with the example in FIG. 1), or a dipole antenna, or a more directive microstrip antenna (traditionally, the gain of a patch antenna is about 6 dB).

The internal repeater IR is intended to be placed on the inner surface IS of the wall WA, substantially substantially facing the external repeater ER. Once again, any type of fastening may be used, in particular suction cups, an adhesive, magnets MG2 (see FIG. 6), or screws.

Said internal repeater IR comprises second electromagnetic coupling means C2 which are coupled to second RF signal transmitting and/or receiving means M2. The latter are, in the example illustrated, of the transmitter-receiver type. They are tasked with receiving the RF signals transmitted by communication terminals CT which are located in the building, and with transmitting (via waves) to said communication terminals CT the RF signals which are transmitted to it by the second electromagnetic coupling means C2 and which come from the base station BS (via the external repeater ER). For this purpose, they may include any type of antenna adapted to the desired application, such as a monopole antenna (as with the example in FIG. 1), or a dipole antenna, or a more directive microstrip antenna.

The first C1 and second C2 electromagnetic coupling means are configured so as to transfer over waves, through the wall WA separating them, the RF signals that respectively come from the first M1 and second M2 RF signal transmitting/receiving means.

Numerous types of RF signal transfers may be used.

For example, the transfer may be carried out through electrical coupling. In such a case, the first C1 and second C2 electromagnetic coupling means are RF antennas which are sensitive to the electric field, such as, for example, microstrip antennas (as illustrated in FIGS. 1 to 4, 6, and 7), or monopole antennas, or dipole antennas.

When microstrip RF antennas C1 and C2 are used (see FIGS. 1 to 4, 6, and 7), they must be placed substantially facing one another, against (or a short distance away from) the outer OS and inner IS surfaces of the wall. It should be noted that these microstrip RF antennas C1 and C2 must be installed in parts of their respective external ER and internal IR repeaters which are at a distance from the parts in which the RF transmitting/receiving means M1 and M2 are installed, so as not to disturb or be disturbed by said transmitting/receiving means.

The signal that is being retransmitted (or repeated) must be kept from disturbing the signal, which is received weakly. In other words, mutual disruptions of the RF transmitting and/or receiving means M1 and M2, disruptions of the first RF transmitting and/or receiving means M1 by the first electromagnetic coupling means C1 (and the other way around), and disruptions of the second RF transmitting and/or receiving means M2 by the second electromagnetic coupling means C2 (and the other way around) must all be avoided. This is why it is currently preferred to use hemispheric microstrip antennas both for the RF transmitting and/or receiving means M1 and M2 and the electromagnetic coupling means C1 and C2.

If the RF signal transmitting and/or receiving means M1 and M2 are also microstrip RF antennas, which is the currently preferred embodiment, said antennas are installed on opposing parts so that they operate in diametrically opposed directions. Now, if the RF signal transmitting and/or receiving means M1 and M2 are monopole RF antennas, it is preferable (as illustrated in FIGS. 1 to 3, 6, and 7) to install these (M1 and M2) on surfaces that are substantially perpendicular to the wall WA of the casings of their respective external ER and internal IR repeaters, such as one on the upper position and the other in a lower position (i.e. one on top and the other on the bottom) in order to be able to benefit from the radio-wave insulation caused by the low radiation cone in the radiation pattern of the monopole antenna, while the microchip RF antennas C1 and C2 are placed on (or nearby) the walls of the casings which are parallel to and are facing the wall WA, so that they are operating on different levels. However, in one variant, and as illustrated in FIG. 4, the monopole RF antennas M1 and M2 may also be placed on opposing walls, parallel to the wall WA, of the casings of their respective internal IR and external ER repeaters (and therefore perpendicular to the wall WA) in order to benefit from the radio-wave insulation caused by the low radiation cone in the radiation pattern.

In a first variant, the transfer may be done by magnetic coupling. In such case, the first C1 and second C2 electromagnetic coupling means are antennas which are sensitive to the magnetic field, such as loop or frame shaped antennas.

When loop or frame shaped antennas C1 and C2 are used, they must be placed substantially facing one another, against (or a at short distance to) the outer OS and inner IS surfaces of the wall WA. It should be noted that these loop or frame antennas C1 and C2 must be installed in parts of their respective internal IR and external ER repeaters which are at a distance from those in which the RF signal transmitting and/or receiving means M1 and M2 are installed, so as not to disturb or be disturbed by said means. For this reason, if the RF signal transmitting and/or receiving means M1 and M2 are monopole RF antennas, said antennas are installed on walls perpendicular to the wall WA (such as in respectively upper or lower positions (or the other way around)) of the casings of their respective internal IR and external ER repeaters, while the loop or frame shaped antennas C1 and C2 are placed on (or nearby) the walls of the casings which are parallel to and are facing the wall WA, so that they are operating on different levels.

In a second variant, the transfer may be done by optic coupling. In such a case, the first C1 and second C2 electromagnetic coupling means may, for example, be optical signal transmitters and/or receivers. For example, the part dedicated to transmission may include an electroluminescent diode. In other words, the optical signals to be transferred are converted into optical signals by the transmitter/receiver of the internal IR, or respectively external ER, repeater, and said optical signals are sent in the direction of, respectively, the transmitter/receiver of the external ER, or respectively internal IR, repeater, where they are reconverted into RF signals.

It should be noted, as illustrated in FIGS. 1, 6, and 7, that the first M1, and respectively second M2, RF signal transmitting and/or receiving means are coupled to the first C1, and respectively second C2, electromagnetic coupling means by an amplification and filtering module AFM1 or AFM2.

As an illustrative and non-limiting example, and as illustrated in FIG. 1, for an FDD radio network, each amplification and filtering module AFM1 (or AFM2) may include two processing branches, respectively dedicated to uplink and downlink transmissions operating on two different frequencies (for example 2.140 GHz downlink and 1.950 GHz uplink). The opposing extremities of these two branches are connected to duplexers D11 and D12 (or D21 and D22), which are themselves connected respectively to the first M1 (or second M2) RF signal transmitting and/or receiving means and the first C1 (or second C2) electromagnetic coupling means.

For example, the branch dedicated to downlink transmissions within the amplification and filtering module AFM1 of the external repeater ER may comprise a first band-pass filter F1, connected to an output of the duplexer D11, and the first amplifier A1 whose input is connected to the output of the first band-pass filter F1 and whose output is connected to an input of the duplexer D12.

For example, the branch dedicated to uplink transmissions within the amplification and filtering module AFM1 of the external repeater ER may comprise:
a second amplifier A2 whose input is connected to an output of the duplexer D12,
a gain adjuster, from an automatic gain control module (or AGC) GCM1, whose input is connected to the output of the second amplifier A2,
a second band-pass filter F2 whose input is connected to the output of the gain adjuster GCM1,
a third amplifier A3 whose input is connected to the output of the second band-pass filter F2,
a gain controller, from the automatic gain control module (or AGC) GCM1, whose input is connected to the output of the third amplifier A3,
a third band-pass filter F3 whose input is connected to the output of the gain controller GCM1 and whose output is connected to an input of the duplexer D11.

It should be noted that the automatic gain control module (or AGC) GCM1 is intended to accommodate dynamic variations in attenuations, such as those between about 30 and 80 dB.

For example, the branch dedicated to uplinks within the amplification and filtering module AFM2 of the internal repeater IR may comprise a first band-pass filter F1′, connected to an output of the duplexer D21, and a first amplifier A1′ whose input is connected to the output of the first band-pass filter F1′ and whose output is connected to an input of the duplexer D22.

For example, the branch dedicated to downlink transmissions within the amplification filtering module AFM2 of the internal repeater IR may comprise:
a second amplifier A2′ whose input is connected to an output of the duplexer D22,
a gain adjuster, from an automatic gain control module (or AGC) GCM2, whose input is connected to the output of the second amplifier A2′,
a second band-pass filter F2′ whose input is connected to the output of the gain adjuster GCM2,
a third amplifier A3′ whose input is connected to the output of the second band-pass filter F2′,
a gain controller, from the automatic gain control module (or AGC) GCM2, whose input is connected to the output of the third amplifier A3′,
a third band-pass filter F3′ whose input is connected to the output of the gain controller GCM2 and whose output is connected to an input of the duplexer D21.

It should be noted that the automatic gain control module (or AGC) GCM2 is intended to accommodate dynamic variations in attenuations, such as those between about 30 and 80 dB.

In order to be able to function, and as illustrated in FIGS. 1 to 7, the external repeater ER and the internal repeater IR respectively include first PM1 and second PM2 electrical power means.

For example, the internal repeater IR may comprise second electrical power means PM2 intended to be connected to a source of alternating current. This source may be a direct connection to the mains, in which case the second electrical power means PM2 are connected to the mains via an electrical connector ES. But in a variant illustrated in FIG. 1, which will be detailed later, the second electrical power means PM2 may be connected to a frequency conversion module FCM tasked with converting the alternating current from the mains, which has a first frequency, into an alternating current with a second frequency higher than the first frequency. In this variant, it is the frequency conversion module FCM which is connected to the mains through an electrical connector ES.

Furthermore, it should be noted that the amplification and filtering module AFM2 of the internal repeater IR requires direct current. Concordantly, as illustrated in FIG. 1, the internal repeater IR comprises, for example, a conversion module CM2 tasked with converting part of the alternating current, originating from the mains or the frequency conversion module FCM, into direct current intended to power at least its amplification and filtering module AFM2.

The electric current which powers the external repeater ER may be of local or outside origin. For example, the external repeater ER may comprise first electrical power means PM1 that include a solar cell and an electric charging circuit connected to the solar cell(s). This electric charging circuit may be connected to a battery intended to provide direct current, at least when the sun is absent. The solar cells may, for example, be those of the sort manufactured by the company Solems.

In one particularly advantageous variant, illustrated in FIGS. 1 to 7, the external repeater ER may be powered by the internal repeater IR. For example, the second electrical power means PM2 may be configured so as to transfer electrical power to the first electrical power means PM1 by inductive coupling.

In such a case, and as illustrated in FIG. 5, the second electrical power means PM2 may, for example, comprise a primary winding PW connected to an alternating current power circuit AC2 connected to the electrical connector EC, potentially via a frequency conversion module FCM, and the first electrical power means may, for example, comprise a secondary winding SW intended to be placed across from the primary winding PW and connected to an electrical charging circuit CC1.

This electrical charging circuit CC1 is then connected to a conversion module CM1 tasked with converting the alternating current from the electrical charging circuit CC1 into direct current intended to power at least the amplification and filtering module AFM1.

It should be noted, as illustrated in FIG. 1, that the external repeater ER may comprise a battery BA powered with direct current by the conversion module CM1. This battery BA is then intended to provide direct current to the external repeater ER, at least during a power failure.

In order to optimize the transfer of power between the primary PW and secondary SW windings, several parameters may be used, in particular those explained in the document by F. Costa, “Transmission d'énergie à distance, Energie portable: autonomie et integration dans l'environnement humain”, (“Remote Power Transmission, Portable Energy: Independence and Integration into the Human Environment”), Mar. 21-22 2002—Cachan—Journées Electrotechniques du Club EEA.

This arises from the fact that the power P transferred from the primary winding PW to the secondary windings SW is given by the formula P=μ₀×ω×(S/2·e)×I², where μ₀ is the dielectric constant within the wall WA (for example, that of air for a window), ω is the angular frequency of the alternating current (a function of the frequency (for example equal to 50 Hz)), S is the surface taken up by the secondary winding SW (defined by its diameter 2A), e is the thickness of the wall WA (for example, equal to 1 or 2 cm for a window), and I is the intensity of the alternating current which is running through the windings (I=N₂×I₂, where N₂ is the number of turns in the primary winding PW).

In this manner, the ratio between the respective external diameters of the primary PW and secondary SW windings may be utilized. The transferred power P (defined by the formula given above) may be increased by using a primary winding PW with an external diameter (equal to 2B) lower than that (equal to 2A) of the secondary winding SW. This enables the secondary winding SW to intercept the magnetic flux caused by the primary winding PW to as great an extent as possible.

As a variant or complement, the transferred power P (defined by the formula given above) may be increased by increasing the angular frequency ω (and therefore the frequency) of the alternating current which powers the primary winding PW through the frequency conversion module FCM.

As a variant or complement, the transferred power P (defined by the formula given above) may be increased by installing flux concentration means FC (see FIG. 6), such as an iron core, into the environment of the primary PW and secondary windings SW.

As a variant or complement, the transferred power P (defined by the formula given above) may be increased by increasing the intensity I of the current running through the primary winding PW, which may be done by using a higher number of turns N₂ in the primary winding PW.

The external repeater ER and the internal repeater IR may be made in a compact and small-sized form, such as by implementing all or part of their components in selected places on printed or integrated circuit boards, and in particular their amplification filtering module (AFM1 or AFM2), their coupling antenna (C1 or C2), and their inductive coupling power means (SW or PW). As illustrated in FIG. 6, is also possible to gather all of the electrical and electronic components of each internal (IR) or external (ER) repeater into a single whole (W1 or W2), other than its inductive coupling power means (SW or PW), if any.

In order to strengthen (or implement) radio-wave insulation for the various antennas (M1, M2, C1 and C2), it is possible to implement a frequency translation (or conversion) technique in the external ER and internal IR repeaters, as illustrated in a variant embodiment in FIG. 7. More precisely, this consists of:
modifying (or converting) the frequency FR1 (for example, equal to 2.140 GHz) of the RF signals received by the first RF signal transmitting and/or receiving means M1 into a frequency FR3 (for example equal to 500 MHz) before transmitting them to the first coupling means C1,
modifying (or converting) the frequency FR2 (for example equal to 1.950 to hertz) of the RF signals received by the second RF signal transmitting and/or receiving means M2 into a frequency FR4 (for example equal to 200 MHz) before transmitting them to the second coupling means C2,
re-modifying (or re-converting) the frequency FR3 of the RF signals transferred to the second coupling means C2 (via the first coupling means C1) to reset it to the frequency FR1 before transmitting them to the second RF signal transmitting and/or receiving means M2, and
re-modifying (or re-converting) the frequency FR4 of the RF signals transferred to the first coupling means C1 (via the second coupling means C2) to reset it to the frequency FR2 before transmitting them to the first RF signal transmitting and/or receiving means M1.

Using this method, the various transmitting and/or receiving antennas M1 and M2 and the various electromagnetic coupling antennas C1 and C2 cannot disturb one another.

In order to achieve the expected outcome, it is possible, as illustrated in FIG. 7 in a non-limiting example:

to insert a first frequency converter (or translator) T1 between the output of the first filter F1 and the input of the first amplifier A1, in the downlink branch of the amplification and filtering module AFM1 of the external repeater ER. This first converter T1 is then tasked with converting the frequency FR1 (for example equal to 2.140 GHz) into a frequency FR3 (for example equal to 500 MHz),

to insert a first frequency converter (or translator) T1′ between the output of the first filter F1′ and the input of the first amplifier A1′, in the uplink branch of the amplification and filtering module AFM2 of the internal repeater IR.

This first converter T1′ is then tasked with converting the frequency FR2 (for example equal to 1.950 GHz) into a frequency FR4 (for example equal to 200 MHz),

to insert a second frequency converter (or translator) T2 between the output of the second amplifier A2 and the input of the gain adjuster GCM1, in the uplink branch of the amplification and filtering module AFM1 of the external repeater ER. This second converter T2 is then tasked with re-converting the frequency FR3 into the frequency FR1, and

to insert a second frequency converter (or translator) T2′ between the output of the second amplifier A2′ and the input of the gain adjuster GCM2, in the downlink branch of the amplification and filtering module AFM2 of the internal repeater IR. This second converter T2′ is then tasked with re-converting the frequency FR4 into the frequency FR2.

In the foregoing, an example implementation of the invention has been described regarding (bidirectional) radio transmissions within a cellular network. However, when the transmissions pertain to (high-frequency) radio or television transmitters, they are unidirectional, i.e. a television (or radio) transmitting station transmitting signals to television (or radio) receivers installed in a space enclosed by walls. In such a case, the repeater device D of the invention may be simplified, in particular in its amplification and filtering modules AFM1 and AFM2. Said modules no longer need any more than a single downlink processing branch, potentially implementing the frequency translation technique described above, without the duplexers. Furthermore, the referenced element M1 of the external repeater ER needs only be a means of receiving RF signals, and the referenced element M2 in the internal repeater IR needs only be a means of transmitting RF signals.

It should be noted that the invention makes it possible to avoid any increase in the number of capacity management and concentration points in the network such as the base station controllers, as well as any redistribution thereof.

The invention is not limited to the embodiments of the repeater device described above, which are given only as examples; rather, it encompasses all variants that a person skilled in the art may envision within the framework of the claims given below.

1. A device (D) for repeating radiofrequency (RF) signals that must be exchanged between a station (BS) on a communication network and a communication terminal (CT) located in a space enclosed by walls, characterized in that it comprises an external repeater (ER) suitable for being placed on an outer surface (OS) of a wall (WA) and comprising first electromagnetic coupling means (C1) coupled to first RF signal transmitting and/or receiving means (M1), and an internal repeater (IR) suitable for being placed on an inner surface of said wall (WA) substantially facing said external repeater (ER) and comprising second electromagnetic coupling means (C2) coupled to second RF signal transmitting and/or receiving means (M2), said first (C1) and second (C2) electromagnetic coupling means being adapted for transferring, over waves, and through said wall (WA), RF signals coming respectively from the first (M1) and second (M2) RF signal transmitting and/or receiving means.

2. A device according to claim 1, characterized in that said first (C1) and second (C2) electromagnetic coupling means are configured in the form of RF antennas sensitive to the electric field.

3. A device according to claim 2, characterized in that said RF antennas (C1, C2) are chosen from a group comprising at least monopole antennas, dipole antennas, and microstrip antennas.

4. A device according to claim 1, characterized in that said first (C1) and second (C2) electromagnetic coupling means are configured in the form of antennas sensitive to the magnetic field.

5. A device according to claim 1, characterized in that said first (C1) and second (C2) electromagnetic coupling means are configured in the form of optical signal transmitters and/or receivers.

6. A device according to claim 1, characterized in that said external repeater (ER) comprises a first electrical power means (PM1), and that said internal repeater (IR) comprises second electrical power means (PM2) connected to a source of alternating current and suitable for transferring electrical power to said electrical power means (PM1) via inductive coupling.

7. A device according to claim 6, characterized in that said second electrical power means (PM2) comprise a primary winding (PW) connected to an alternating current power circuit (AC2), and that said first electrical power means (PM1) comprise a secondary winding (SW) that is suitable for being placed facing said primary winding (PW) and is connected to an electrical charging circuit (CC1) adapted for delivering alternating current.

8. A device according to claim 7, characterized in that said primary winding (PW) has a diameter less than that of said secondary winding (SW).

9. A device according to claim 7, characterized in that the first (PM1) and/or second (PM2) electrical power means comprise flux concentration means (FC).

10. A device according to claim 8, characterized in that said second electrical power means (PM2) comprise conversion means (FCM) adapted for converting an alternating current with a first frequency into an alternating current with a second frequency greater than the first frequency.

11. A device according to claim 8, characterized in that said second electrical power means comprise a high number of turns.

12. A device according to claim 1, characterized in that said external repeater (ER) comprises independent first electrical power means (PM1).

13. A device according to claim 12, characterized in that said first electrical power means (PM1) comprise a solar cell and an electrical charging circuit connected to said solar cell(s) and adapted for delivering direct current.

14. A device according to claim 6, characterized in that said first electrical power means (PM1) comprise a battery (BA) connected to said electrical charging circuit (CC1).

15. A device according to claim 6, characterized in that said first (PM1) and/or second (PM2) electrical power means comprise conversion means (CCM1, CCM2) adapted for converting alternating current into direct current.

16. A device according to claim 1, characterized in that said external repeater (ER) comprises first frequency conversion means (T1) adapted for converting a first frequency exhibited by the RF signals received by said first RF signal transmitting and/or receiving means (M1) into a third frequency before transmitting said RF signals to said first electromagnetic coupling means (C1), and in that said internal repeater (IR) comprises second frequency conversion means (T2′) adapted for converting said third frequency exhibited by the RF signals transferred to said second electromagnetic coupling means (C2), via said first electromagnetic coupling means (C1), in order to reset it to the first frequency before transmitting them to said second RF signal transmitting and/or receiving means (M2).

17. A device according to claim 1, characterized in that said internal repeater (IR) comprises first frequency conversion means (T1′) adapted for converting a second frequency exhibited by the RF signals received by said second RF signal transmitting and/or receiving means (M2) into a fourth frequency before transmitting said RF signals to said second electromagnetic coupling means (C2), and in that said external repeater (ER) comprises second frequency conversion means (T2) adapted for converting said fourth frequency exhibited by the RF signals transferred to said first electromagnetic coupling means (C1), via said second electromagnetic coupling means (C2), in order to reset it to the second frequency before transmitting them to said first RF signal transmitting and/or receiving means (M1).
